(19) United States
(12) Patent Application Publication
(10) Pub. No.: US 2008/0233796 A1
(43) Pub. Date: Sep. 25, 2008

(54) Plug or Coupler of Coaxial Plug-In Connection in a Waterproof Embodiment

(76) Inventor: Ivica Segrt, Deckenpfronn (DE)

Correspondence Address: K.F. ROSS P.C., 5683 RIVERDALE AVENUE, SUITE 203 BOX 900, BRONX, NY, 10471-0900, US

(21) Appl. No.: 10/572,536

(22) PCT Filed: Sep. 20, 2004
(86) PCT No.: PCT/EP2004/010533

§ 371 Date: Mar. 17, 2006

(30) Foreign Application Priority Data
Sep. 20, 2003 (DE) 103 43 716.9

(51) Int. Cl. H01R 9/05

(52) U.S. Cl. 439/578

(57) ABSTRACT

Disclosed is a plug (1) or coupler of a coaxial plug-in connection, especially an antenna plug, which can be joined to a wire (5) and a corresponding coupler. Said plug (1) or coupler comprises an outer conductor sleeve (3) that is made of a conducting material, and an insulator (8) which is disposed within a plug sleeve area of the outer conductor sleeve (3) and is provided with a contact pin (9). A sealing element (7) is disposed between the outer conductor sleeve (3) and the outer sheath of the wire (5) at the end facing away from the contact pin (9) while the plug sleeve (4) is provided with a seal (10) or a sealing surface.

The invention relates to a plug of a coaxial plug-in connection, which can be joined to a cable and a corresponding coupler, especially an antenna plug, with an outer conductive sleeve made of a conductive material and an insulator disposed within a plug sleeve area of the outer conductive sleeve having a contact pin, according to the features of the preamble of claim 1.

The invention also relates to a coupler of a coaxial plug-in connection, which can be joined to a cable and a corresponding plug, especially an antenna coupler, with an outer conductive sleeve made of a conductive material and an insulator disposed within a plug-in sleeve area of the outer conductive sleeve having a contact element, according to the features of the preamble of claim 17.

A category-forming plug is known from DE 196 09 571 A1. The outer conductive sleeve of this plug is made of metal and capable of guiding the cable and establishing the electrical contact to the shielding braid of the cable as well as connecting the inner conductor of the cable to the contact pin. The plug can be also connected to a coupler made also of metal and be locked therewith.

Such a plug or coupler or such a plug coupler connection is sure capable of establishing a cable connection in protected dry spaces. However, the plug and the plug connection is not capable of warranting a secure connection in areas e.g. outside of vehicles exposed to moisture, splash water and other influences.

Hence, it is the object of the invention to provide a plug and a coupler in which both the cable and the plug coupler unit are designed waterproof, so that this plug and coupler also can be used outside a vehicle. The plug and coupler shall be also service friendly and make it possible to exchange it in case of damage.

This objective is solved by the features of claim 1 and 17.

According to invention it is provided for the plug (also in the claims 1 to 16) that a seal element is disposed between the outer conductive sleeve and the outer sheath of the cable at the end facing away from the contact pin and that the plug sleeve has a seal or a seal surface. With this design it is secured that moisture cannot permeate between the outer sheath of the cable and the outer conductive sleeve and that the plug is sealed up by means of the seal with respect to the corresponding component of the coupling or by means of the seal surface at a seal of the corresponding component of the coupler. Thereby it is assumed that the coupler is sealed up in a corresponding way, so that water or moisture does not permeate also from inside of the coupler.

In a further design of the invention it is proposed that the seal is formed as a seal ring at its end of the plug sleeve facing the cable having a ring surface with a reduced diameter facing the free end of the plug sleeve. With this design it is achieved that the seal surface of the corresponding component of the coupler is attached securely on the seal ring during coupling. The seal ring is placed in a groove of the plug sleeve, so that it is also fixed axially. In front of the seal ring in the direction of the free end of the plug sleeve the plug sleeve has a ring-shaped ramp through which a guiding and a conductive contact can be established to the corresponding component of the coupler.

For improving the conductive contacting between the plug sleeve and a corresponding component of the coupler, on the outer periphery of the plug sleeve a contact sleeve is disposed attached to the plug-in sleeve of the coupler. It is formed undulated, resilient and electrically conductive, so that it warrants a radial contact between the plug sleeve and a corresponding component of the coupler. It shall be pointed out that only one contact sleeve is provided, so that before the coupling of the plug to the corresponding coupler the described contact sleeve is placed whether on the plug sleeve or within the corresponding component of the coupler.

In an advantageous way the outer conductive sleeve is placed in a holder, wherein the holder has a locking slider engageable behind a bulge-like enlargement on the outer conductive sleeve. Thereby, after assembly of the outer conductive sleeve with the holder, a secure axial fixation is established by the locking slider. To prevent also a permeation of moisture between the outer conductive sleeve and the holder it is proposed that the seal element between the outer sheath of the cable and the outer conductive sleeve overlaps the outer conductive sleeve and is attached seal up to the holder.

For the axial fixation of the outer conductive sleeve in the holder the outer conductive sleeve has a shoulder attached to a restriction at the holder. Thereby the fixation of the holder with respect to the outer conductive sleeve is preferably carried out in the one axial direction. The locking slider has for a secure form-fit locking two fingers reaching through openings in the holder up to both sides of the bulge-like enlargement on the outer conductive sleeve, so that after engagement of the fingers in the openings in the holder the fixation is carried out in the counter direction to the shoulder.

It shall be pointed out that depending from the design of the bulge-like enlargement also a fixation of the holder to the outer conductive sleeve can be carried out only through the fingers, if e.g. subsequent to the bulge-like enlargement in the outer conductive sleeve a groove is provided which is engaged by the fingers, so that a fixation in both directions can take place through the fingers.

In a further design of the invention it is proposed that the locking slider has a support body on which the fingers are mounted, wherein at the support body further at least two clips are mounted corresponding to recesses at the holder. The clips and recesses are provided to fix the locking slider to the holder. In an advantageous way several recesses disposed in series in the locking direction are provided, whereby a pre-locking and a final-locking of the locking slider to the holder can take place.

To prevent also the permeation of moisture into the area of the openings in the holder it is proposed that a seal is provided at the support body and/or at one support surface of the holder facing the support body. The seal can be designed user-defined, e.g. as flat seal or as a sprayed-on seal disposed on the support body or at the support surface or also as seal ring disposed in a groove of the support body or the support surface. In an advantageous way the holder is designed rectangularly seen in cross section at its perimeter, so that the support surface and the corresponding surface of the support body are designed planar. It is also possible that the holder is designed circularly seen in cross section at its outer perimeter, so that then the inner surface of the support body is formed correspondingly and the seal is adapted to the curvature.

In the outer surface of the holder a recess is provided in an advantageous way corresponding in about to the thickness and the outer contour of the support body. Thereby the support body forms in the final-locking position a planar smooth unit with the adjacent surface.

For connecting the holder to a corresponding holder of the coupler the holder of the plug has a plug neck attached to a coupling guide of the holder of the coupler, wherein the plug neck has a seal ring or a seal surface. The seal ring is disposed at the outer perimeter of the plug neck and placed in a groove, so that the axial fixation is warranted. If the plug neck is now introduced into the coupling guide, also this transition area is sealed up.

In an advantageous way the holder has a locking element attached to a locking counter part at the holder of the coupler. If the carrier bodies are coupled to each other, it is warranted by the locking element and the locking counter part that they are fixed in their position against each other.

According to invention it is provided for the coupler (also in claims 17 to 32) that a seal element is disposed between the outer conductive sleeve and the outer sheath of the cable at the end facing away from the contact element and that the plug-in sleeve has a seal surface or a seal. This design ensures that on the one hand the cable in the outer conductive sleeve is sealed clearly defined and that further the plug-in sleeve being joined to a plug is also sealed thereto. In an advantageous way the seal surface is disposed at the free end of the plug-in sleeve and corresponds to a seal at the plug or the seal is provided at the end of the plug-in sleeve facing the cable and can come into an active connection with a seal surface at the corresponding part of the plug.

The seal surface at the end of the plug-in sleeve has in an advantageous way an outer chamfer, a ring surface and an inner chamfer. The outer chamfer serves to engage and to seal the seal at the plug, wherein the ring surface appears as main seal surface. The inner chamfer itself can take the metallic guide and electrical conduction with a corresponding counter surface at the plug. The described seal surface is preferably disposed inside the plug-in sleeve and attached to a seal at a plug sleeve of the plug, wherein the seal at the plug sleeve is disposed in the outer area.

To warrant a secure electrical conduction, even if the inner chamfer is not clearly in an active connection with the corresponding surface at the plug, within the plug-in sleeve a contact sleeve is placed disposed in the assembled state between the plug-in sleeve and the corresponding plug sleeve of the plug.

This contact sleeve is preferably of a resilient material designed undulated and formed circular, so that it warrants both to the plug-in sleeve and also to the plug sleeve a defined electrical contact.

In an advantageous way the outer conductive sleeve is placed in a holder, wherein the holder has a locking slider engageable behind a bulge-like enlargement on the outer conductive sleeve. The outer conductive sleeve further has a shoulder attached to at least a protrusion at the holder. Thereby it is secured that the outer conductive sleeve is firmly defined axially in the holder both in the one direction in connection with the shoulder and the protrusion and in the other direction by the locking slider.

In an advantageous way the locking slider has two fingers reaching through openings in the holder up to both sides of the bulge-like enlargement on the outer conductive sleeve. With this design a defined locking function arises as the fingers on the one hand engage in the openings in the holder and on the other hand at the bulge-like enlargement on both sides of the outer conductive sleeve and lock therewith. Depending from the design of the fingers and the counter surfaces on the outer conductive sleeve and the holder these are also capable of warranting a fixation in both axial directions, if a recess in the holder with oppositely directed shoulders and a groove provided next to the bulge-like enlargement are attached to the fingers in the outer conductive sleeve engaged by the fingers.

The locking slider further has a support body on which the fingers are mounted, wherein at the support body further at least two clips are mounted corresponding to recesses at the holder. The clips encompass in an advantageous way the holder at its outer wall, so that they can engage the recesses and warrant a defined fixation of the locking slider. To warrant a pre- and final-locking several recesses are disposed in series in the locking direction, so that the clips define in the first recesses in the locking direction a pre-locking, while the further recesses define the final-locking.

To warrant that moisture or water does not permeate through the openings in the holder up to the outer conductive sleeve it is proposed that a seal is provided at the support body and/or at one support surface of the holder facing the support body. The seal can be designed as flat seal as well as a seal sprayed on one of the components or as seal ring disposed in a groove of the support body or the support surface.

In an advantageous way in the outer surface of the holder a recess is provided corresponding in about to the thickness and the outer contour of the support body. Thereby the support body or the locking slider forms with the adjacent surface of the holder a planar smooth unit not capable of getting stuck with protruding parts. The holder can be designed e.g. rectangularly seen in cross section at its outer surface, so that a flat seal surface results at the support body or at the support surface. The holder can also be designed substantially round seen in cross section and the support body can have a corresponding cylindrical form, so that the seal and the outer surface of the support body is adapted to these forms.

To warrant that also a direct seal between the cable and the holder is provided it is proposed that the seal element between the outer conductive sleeve and the outer sheath of the cable overlaps the outer conductive sleeve and is attached seal up to the holder. Thereby it is warranted that despite of the seal between the support body at the locking slider and the holder moisture or water does not permeate from the cable side between the outer conductive sleeve and the holder.

The holder further has a coupling guide attached to a plug neck of a holder of the plug, wherein the coupling guide has a seal surface or a seal. This design between the coupling guide and the plug neck is formed similarly to the seal between the plug-in sleeve and the plug sleeve, wherein the seal surface or seal at the coupling guide prevents the permeation of water between the holder at the coupler and the holder at the plug.

In an advantageous way the holder has a locking element attached to a locking counter part at the holder of the plug, so that after final connection of the coupler to the plug a locking of the carrier bodies against each other can take place.

For further explanation of the invention it is referred to the drawings in which an embodiment of the invention, however to which the invention is not limited, is represented simplified. Therein:

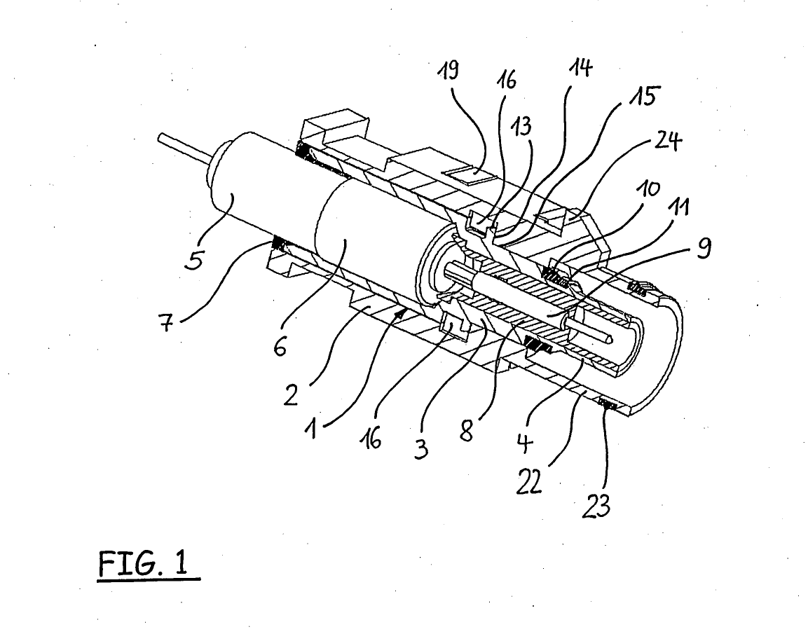

FIG. 1 is a section through a plug with holder in a perspective view;

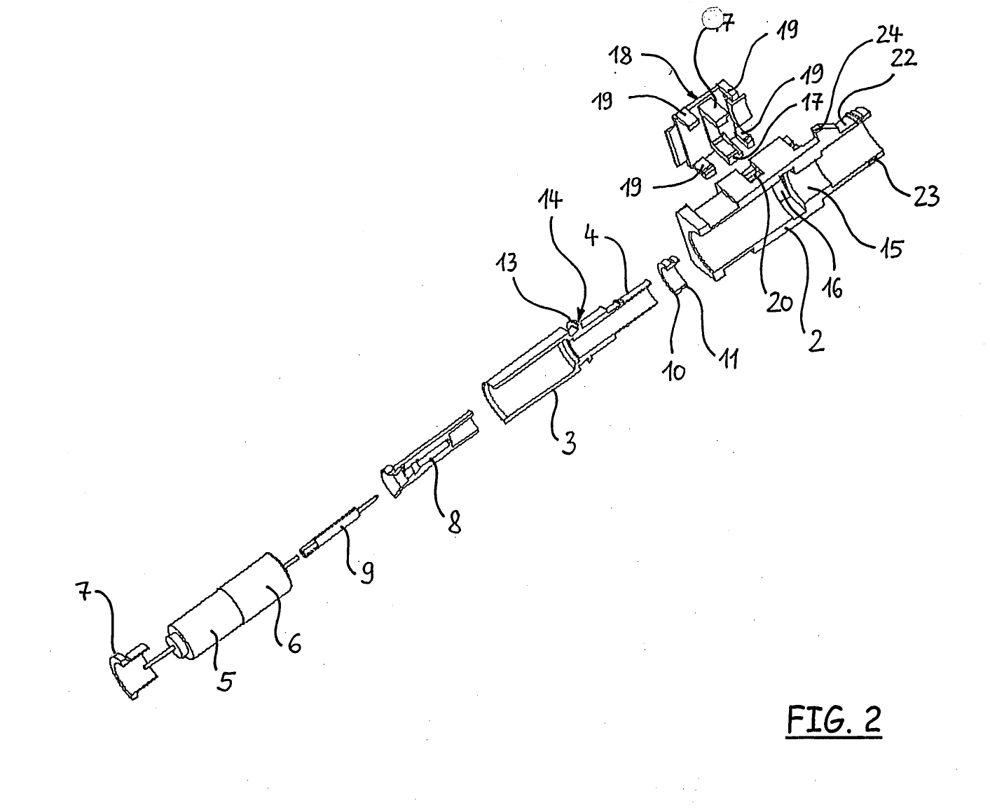

FIG. 2: is a section through a plug with holder in an exploded view;

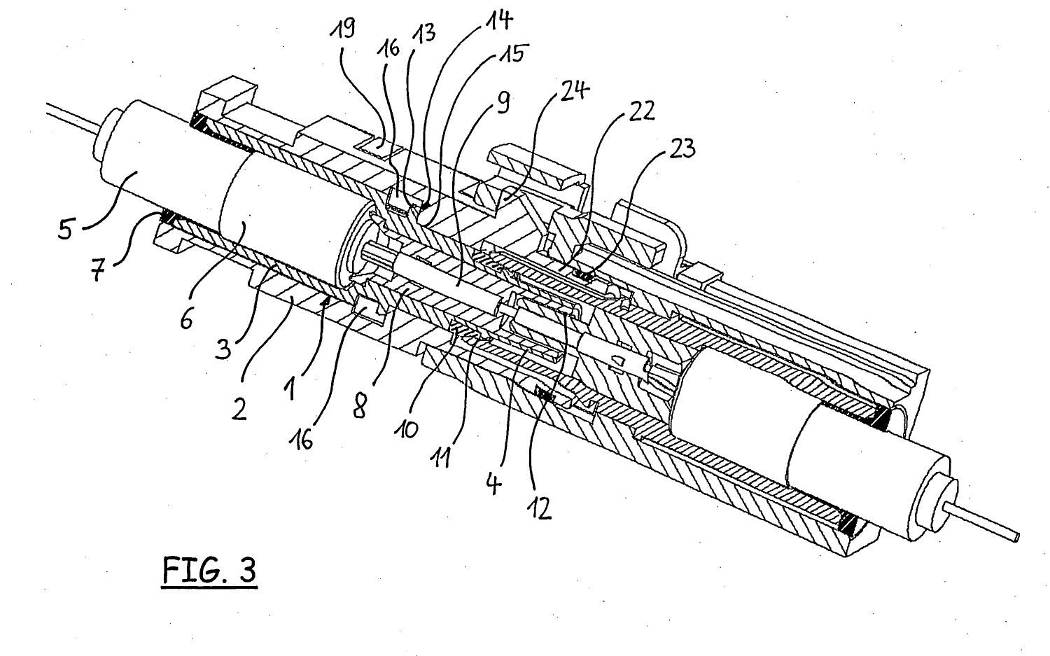

FIG. 3 shows a plug according to FIG. 1 joined to a corresponding coupler;

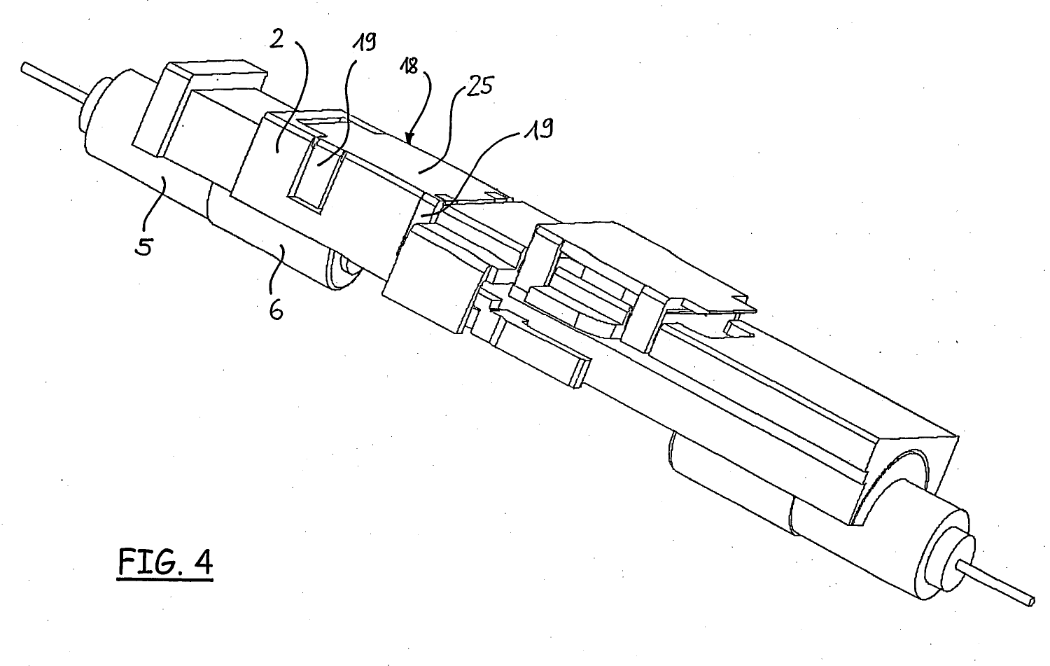

FIG. 4 shows an outer view of a sectioned plug with holder coupled to a coupler with holder in a perspective representation; and

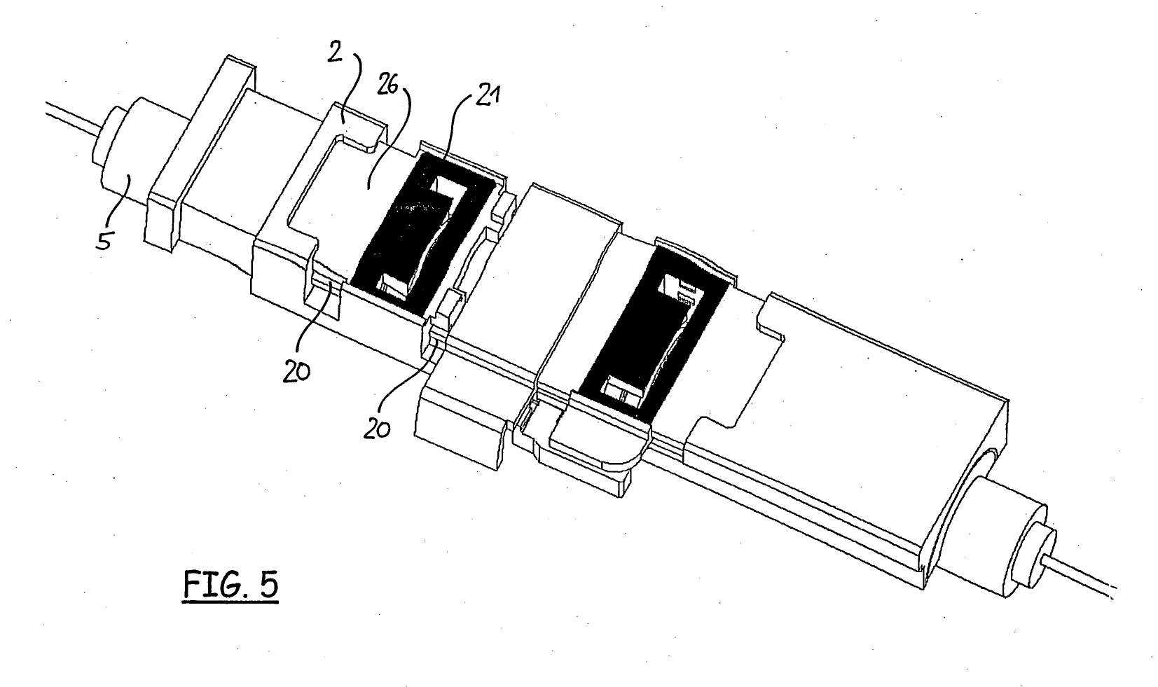

FIG. 5 shows a plug and coupler with holder according to FIG. 4 in a top view;

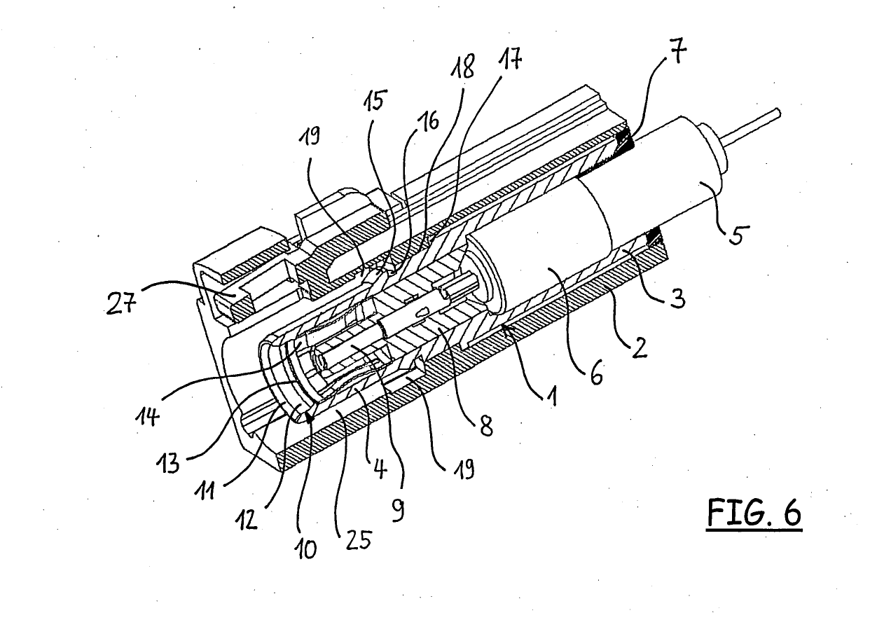

FIG. 6 is a section through a coupler in a waterproof design with a holder;

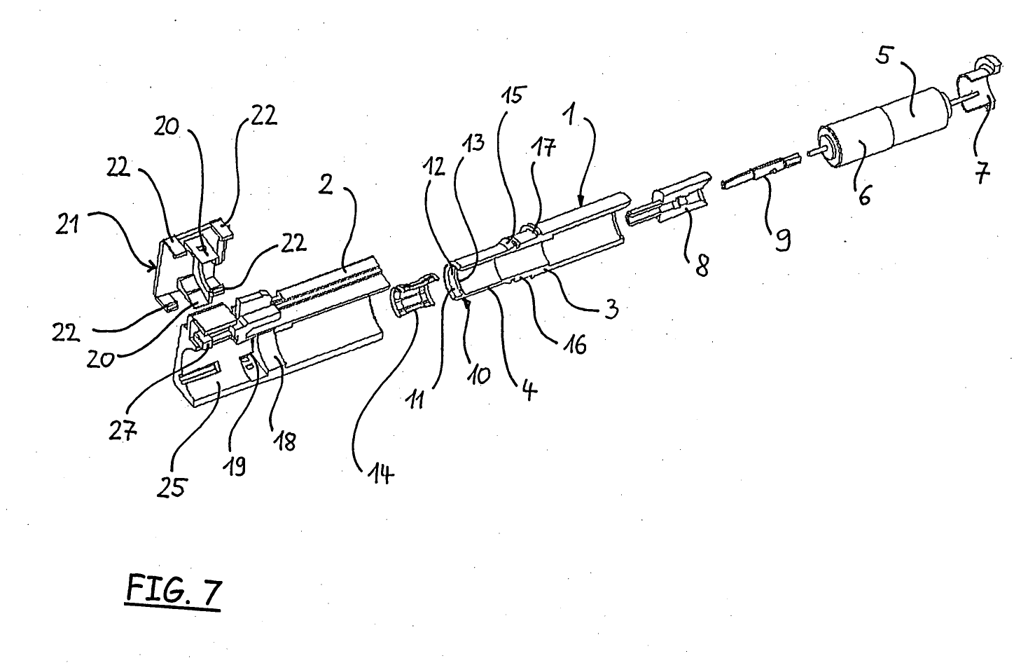

FIG. 7 shows the parts of the coupler and holder according to FIG. 6 in an exploded representation;

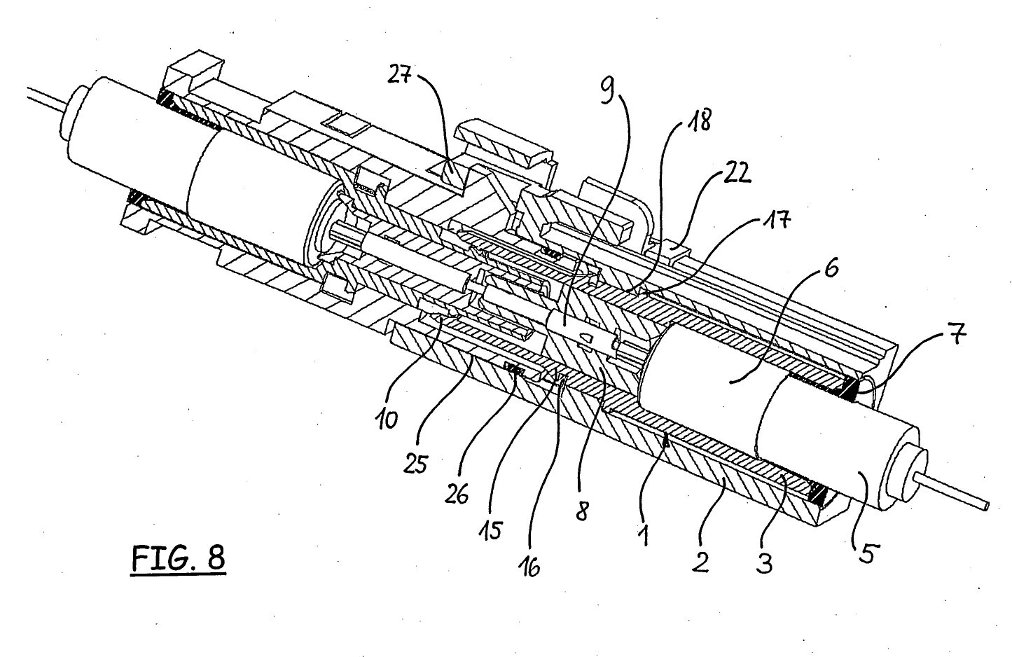

FIG. 8 shows a coupler and holder according to FIG. 7 assembled with a corresponding plug and holder;

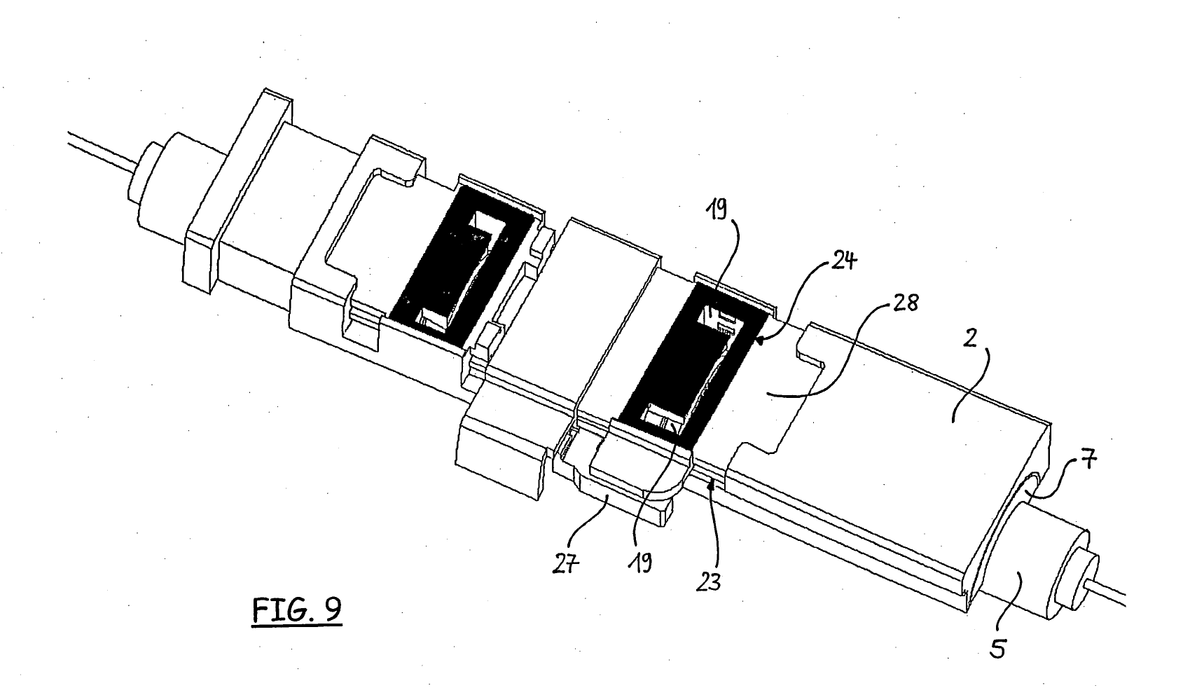

FIG. 9 is an outer view of carrier bodies of a coupler and a plug in a joined design without locking slider; and

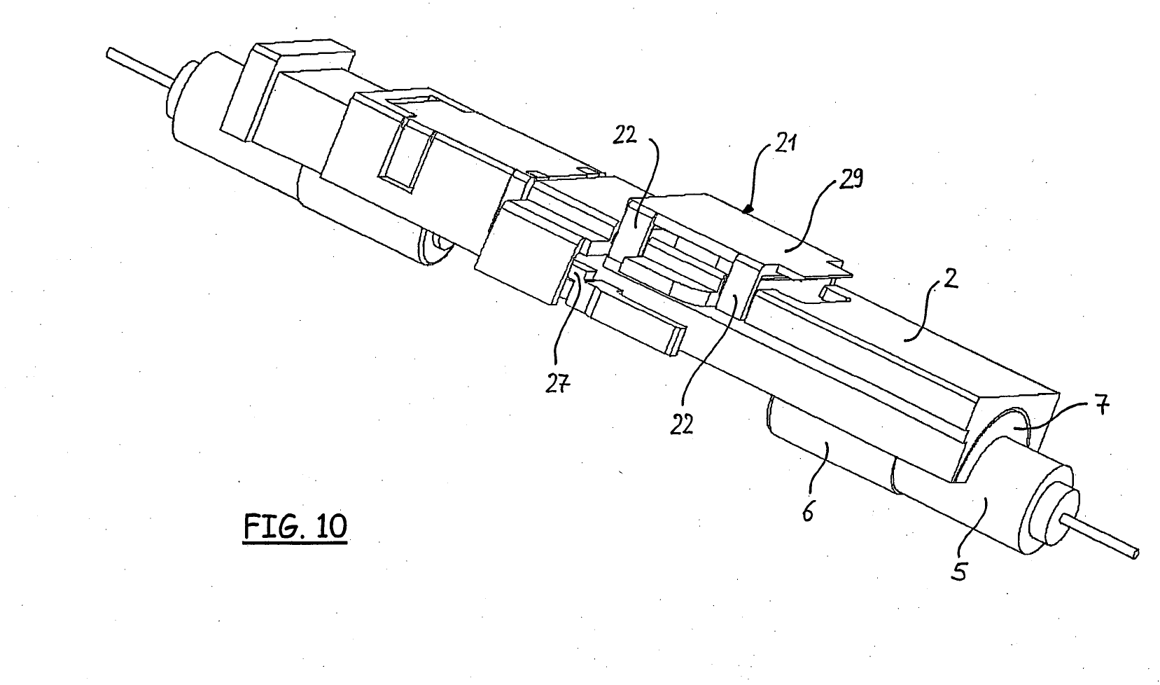

FIG. 10 shows an embodiment similar to FIG. 9 with partially and completely engaged locking sliders.

In FIGS. 1 to 5 (showing a plug), as far as shown in detail, a plug is referred to with 1 disposed within a holder 2. The plug 1 has an outer conductive sleeve 3 on which a plug sleeve 4 is formed. Within the outer conductive sleeve a cable 5 is placed the shielding braid 6 of which is upended and is in electrical contact with the outer conductive sleeve 3. The cable 5 is sealed by means of a seal element 7 with respect to the outer conductive sleeve 3 and the holder 2. Within the outer conductive sleeve 3 is further placed an insulator 8 carrying a contact pin 9 the free end of which protrudes into the plug sleeve area. At the end of the plug sleeve 4 facing the cable 5 a seal 10 is attached having a ring area 11 with reduced diameter at its area facing the free end of the plug sleeve 4. The seal is placed in a groove, so that it is axially fixed. On the side of the seal toward the plug sleeve 4 is a ring-shaped ramp that guides a corresponding component of a coupler and establishes a metallic contact to a chamfer at the coupler. At the outer surface of the outer conductive sleeve 3 is further disposed a bulge-like enlargement 13 aligned openings 16 in the holder 2. The bulge-like enlargement 13 forms further a shoulder 14 standing with a restriction 15 at the holder 2 in an active connection, so that the restriction 15 and the shoulder 14 fix the holder on the outer conductive sleeve after insertion of the outer conductive sleeve into the holder or vice versa.

As can be seen especially in FIG. 2 a locking slider 18 is provided having fingers 17 which can be inserted into the openings 16. The locking slider 18 further has four clips 19 fitting in recesses 20 at the outer surface of the holder, so that after insertion of the locking slider with the fingers into the openings a locking of the locking slider with the clips at the recesses takes place. Between the holder 2 and the inner surface of the locking slider a seal 21 is provided (FIG. 5) formed as flat seal and preventing the entry of water or moisture into the openings 16. However, the seal can be also formed as ring seal placed in a groove at the holder or at the locking slider or as sprayed-on seal or the like. The holder 2 further has a plug neck 22 on which a seal ring 23 is disposed. The seal ring 23 is fitted in a groove that fixes it in place. Further at the holder 2 a locking element 24 is mounted shaped as a nose, so that a locking counterpart at the holder of the coupler formed as a hook can engage behind the nose.

In FIGS. 6 to 10 (with respect to a coupler), as far as shown in detail, a coupler is referred to with 1 placed within a holder 2. The coupler 1 has an outer conductive sleeve 3 formed at its one end as plug-in sleeve 4. The opposite end of the outer conductive sleeve 3 is formed for receiving a cable 5 the upended shielding braid 6 of which is attached to the outer conductive sleeve 3 and establishes an electrical contact with it. Outside to the shielding braid between the cable 5 and the outer conductive sleeve 3 a seal element 7 is placed overlapping the outer conductive sleeve and is attached to seal the holder 2. Within the outer conductive sleeve 3 is disposed an insulator 8 carrying a contact element 9 electrically connected to the inner conductor of the cable 5. The plug-in sleeve 4 has at its free inner end a seal surface 10 with an outer chamfer 11 of a ring surface 12 and an inner chamfer 13. Further within the plug-in sleeve 4 a contact sleeve 14 is disposed made of undulated resilient and conductive material and formed with a plug sleeve of the plug for contacting the plug-in sleeve 4.

The outer conductive sleeve 3 has at its outer perimeter a bulge-like enlargement 15 formed ring-shaped. Attached to the bulge-like enlargement 15 is a ring groove 16. Subsequent to it is a sleeve-like area and a protrusion 17 also formed ring-shaped. With this design the holder 2 can be inserted over the coupler 1 or the outer conductive sleeve 3 or it can be inserted into the holder 2, wherein the holder 2 has a restriction 18 forming with the shoulder 17 of the outer conductive sleeve a stopper. Laterally to the bulge-like enlargement 15 and the ring groove 16 are disposed openings in the holder 2 formed for receiving of fingers 20 (FIG. 7) of a locking slider 21. The locking slider 21 further has four clips 22 corresponding to recesses 23 at the holder 2 (FIG. 9), wherein several recesses are provided in series to enable a primary and secondary locking of the locking slider 21 at the holder 2. The holder 2 is designed rectangularly seen in cross section at its outer perimeter, so that planar surfaces result for the locking slider 21. The holder 2 has at its outer surface in the area of the locking slider 21 a seal 24 generating a clear seal after secondary locking of the locking slider 21 with a support body 29 of the locking slider 21.

The holder 2 further has a coupling guide 25 acting together with a plug neck of the holder of the plug. To generate a clear seal also between the plug neck and the coupling guide the plug neck of the holder of the plug (FIG. 8) carries a seal ring 26. In the area of the locking slider the holder 2 has a recess adapted to the thickness and the outer contour of the support body 29, so that the support body is flush with the holder 2 after the effected secondary locking.

At the holder 2 further is mounted a locking element 27 attached to a locking counter part at the holder of the plug. The locking element 27 is formed as a hook pivotably mounted to the holder 2 and engaging behind the locking counter part at the holder of the plug.

### REFERENCE LIST FIG. 1 TO 5

1 plug
2 holder
3 outer conductive sleeve
4 plug sleeve
5 cable
6 shielding braid
7 seal element
8 insulator
9 contact pin
10 seal
11 ring surface
12 contact sleeve
13 bulge-like enlargement
14 shoulder
15 restriction
16 openings
17 finger
18 locking slider
19 clips
20 recesses
21 seal
22 plug neck
23 seal ring
24 locking element
25 support body
26 recess

### REFERENCE LIST FIG. 6 TO 10

1 coupler
2 holder
3 outer conductive sleeve
4 plug-in sleeve
5 cable
6 shielding braid
7 seal element
8 insulator
9 contact element
10 seal surface
11 outer chamfer
12 ring surface
13 inner chamfer
14 contact sleeve
15 bulge-like enlargement
16 ring groove
17 shoulder
18 restriction
19 openings
20 finger
21 locking slider
22 clips
23 recesses
24 seal
25 coupling guide
26 seal ring
27 locking element
28 recess
29 support body

1. A plug (1) of a coaxial plug-in connection, which can be joined to a cable (5) and a corresponding coupler, especially an antenna plug, with an outer conductive sleeve (3) made of a conductive material and an insulator (8) disposed within a plug sleeve area of the outer conductive sleeve (3) having a contact pin (9), characterized in that a seal element (7) is disposed between the outer conductive sleeve (3) and the outer sheath of the cable (5) at the end facing away from the contact pin (9) and that the plug sleeve (4) has a seal (10) or a seal surface.

2. The plug (1) of a coaxial plug-in connection according to claim 1, characterized in that the seal (10) is disposed at its end of the plug sleeve (4) facing the cable (5) and that the seal surface is provided at the free end of the plug sleeve (4).

3. The plug (1) of a coaxial plug-in connection according to claim 1, characterized in that the seal (10) is formed as a seal ring having a ring surface (11) with a reduced diameter facing the free end of the plug sleeve (4).

4. The plug (1) of a coaxial plug-in connection according to claim 1, characterized in that the seal (10) is disposed on the outer periphery of the plug sleeve (4) and is attached to a seal surface of a plug-in sleeve of a coupler.

5. The plug (1) of a coaxial plug-in connection according to claim 1, characterized in that on the outer periphery of the plug sleeve (4) a contact sleeve (12) is disposed attached to the plug-in sleeve of the coupler.

6. The plug (1) of a coaxial plug-in connection according to claim 1, characterized in that the outer conductive sleeve (3) is placed in a holder (2), wherein the holder (2) has a locking slider (18) engageable behind a bulge-like enlargement (13) on the outer conductive sleeve (3).

7. The plug (1) of a coaxial plug-in connection according to claim 1, characterized in that the seal element (7) overlaps the outer conductive sleeve (3) and is attached seal up to the holder (2).

8. The plug (1) of a coaxial plug-in connection according to claim 1, characterized in that the outer conductive sleeve (3) has a shoulder (14) attached to a restriction (15) at the holder (2).

9. The plug (1) of a coaxial plug-in connection according to claim 1, characterized in that the locking slider (18) has two fingers (17) reaching through openings (16) in the holder (2) up to both sides of the bulge-like enlargement (13) on the outer conductive sleeve (3).

10. The plug (1) of a coaxial plug-in connection according to claim 1, characterized in that the locking slider (18) has a support body (25) on which the fingers (17) are mounted, wherein at the support body further at least two clips (19) are provided corresponding to recesses (20) at the holder (2).

11. The plug (1) of a coaxial plug-in connection according to claim 10, characterized in that several recesses (20) disposed in series in the locking direction are provided.

12. The plug (1) of a coaxial plug-in connection according to claim 1, characterized in that a seal (21) is provided at the support body (25) and/or at one support surface of the holder (2) facing the support body.

13. The plug (1) of a coaxial plug-in connection according to claim 1, characterized in that the seal (21) is formed as a seal ring disposed in a groove of the support body (25) or the support surface.

14. The plug (1) of a coaxial plug-in connection according to claim 1, characterized in that the holder (2) has on its surface facing the support body (25) a recess (26) corresponding in about to the thickness and the outer contour of the support body (25).

15. The plug (1) of a coaxial plug-in connection according to claim 1, characterized in that the holder (2) has a plug neck (22) attached to a coupling guide of a holder of the coupler, wherein the plug neck (22) has a seal ring (23) or a seal surface.

16. The plug (1) of a coaxial plug-in connection according to claim 1, characterized in that the holder (2) has a locking element (24) attached to a locking counter part at the holder of the coupler.

17. A coupler (1) of a coaxial plug-in connection, which can be joined to a cable (5) and a corresponding plug, especially an antenna coupler, with an outer conductive sleeve (3) made of a conductive material and an insulator (8) disposed within a plug-in sleeve area of the outer conductive sleeve (3) having a contact element (9), characterized in that a seal element (7) is disposed between the outer conductive sleeve (3) and the outer sheath of the cable (5) at the end facing away from the contact element (9) and that the plug-in sleeve (4) has a seal surface (10) or a seal.

18. The coupler (1) of a coaxial plug-in connection according to claim 17, characterized in that the seal surface (10) is disposed at the free end of the plug-in sleeve (4) and that the seal is provided at its end of the plug-in sleeve (4) facing the cable (5).

19. The coupler (1) of a coaxial plug-in connection according to claim 17, characterized in that the seal surface (10) has an outer chamfer (11), a ring surface (12) and an inner chamfer (13).

20. The coupler (1) of a coaxial plug-in connection according to claim 17, characterized in that the seal surface (10) is disposed inside the plug-in sleeve (4) and attached to a seal at a plug sleeve of the plug.

21. The coupler (1) of a coaxial plug-in connection according to claim 17, characterized in that within the plug-in sleeve (4) a contact sleeve (14) is placed attached to the plug sleeve of the plug.

22. The coupler (1) of a coaxial plug-in connection according to claim 17, characterized in that the outer conductive sleeve (3) is placed in a holder (2), wherein the holder (2) has a locking slider (21) engageable behind a bulge-like enlargement (15) on the outer conductive sleeve (3).

23. The coupler (1) of a coaxial plug-in connection according to claim 17, characterized in that the seal element (7) overlaps the outer conductive sleeve (3) and is attached seal up to the holder (2).

24. The coupler (1) of a coaxial plug-in connection according to claim 17, characterized in that the outer conductive sleeve (3) has a shoulder (17) attached to at least a restriction (18) at the holder (2).

25. The coupler (1) of a coaxial plug-in connection according to claim 17, characterized in that the locking slider (21) has two fingers (20) reaching through openings (19) in the holder (2) up to both sides of the bulge-like enlargement (15) on the outer conductive sleeve (3).

26. The coupler (1) of a coaxial plug-in connection according to claim 17, characterized in that the locking slider (21) has a support body (29) on which the fingers (20) are mounted, wherein at the support body (29) further at least two clips (22) are mounted corresponding to recesses (23) at the holder (2).

27. The coupler (1) of a coaxial plug-in connection according to claim 26, characterized in that several recesses (23) disposed in series in the locking direction are provided.

28. The coupler (1) of a coaxial plug-in connection according to claim 17, characterized in that a seal (24) is provided at the support body (29) and/or at one support surface of the holder (2) attached to the support body (29).

29. The coupler (1) of a coaxial plug-in connection according to claim 17, characterized in that the seal (24) is formed as a seal ring disposed in a groove of the support body (29) or the support surface.

30. The coupler (1) of a coaxial plug-in connection according to claim 17, characterized in that the holder (2) has on its surface facing the support body (29) a recess (28) corresponding in about to the thickness and the outer contour of the support body (29).

31. The coupler (1) of a coaxial plug-in connection according to claim 17, characterized in that the holder (2) has a coupling guide (25) attached to a plug neck of a holder of the plug, wherein the coupling guide (25) has a seal surface or a seal.

32. The coupler (1) of a coaxial plug-in connection according to claim 17, characterized in that the holder (2) has a locking element (27) attached to a locking counterpart at the holder of the plug.
